(19) United States
(12) Patent Application Publication
(10) Pub. No.: US 2025/0343253 A1
(43) Pub. Date: Nov. 6, 2025

(54) FUEL CELL SYSTEM COMPRISING A FUEL CELL STACK AND A REFORMER

(71) Applicant: PowerCell Sweden AB, Gothenburg (SE)

(72) Inventors: Johan BURGREN, Gothenburg (SE); Thomas SALEMAN, Västra Frolunda (SE)

(21) Appl. No.: 18/776,291

(22) Filed: Jul. 18, 2024

(30) Foreign Application Priority Data
May 3, 2024 (SE) 24302531

(51) Int. Cl. H01M 8/0612; C01B 3/36; H01M 8/04082; H01M 8/04089; H01M 8/04223; H01M 8/0662; H01M 8/2475

(52) U.S. Cl. CPC H01M 8/0631; C01B 3/363; H01M 8/04089; H01M 8/04201; H01M 8/04231; H01M 8/0662; H01M 8/2475; C01B 2203/0255; C01B 2203/0822; C01B 2203/1235

(57) ABSTRACT

Fuel cell system comprising at least one fuel cell stack and a reformer unit, wherein the reformer unit is adapted to convert hydrocarbon fuel into a hydrogen rich gas. The reformer unit comprises an oxidizing agent inlet, a hydrocarbon fuel inlet, a reaction chamber, where the oxidation agent and the hydrocarbon fuel are reacted to hydrogen rich gas and byproducts, and a reaction chamber outlet for exiting the hydrogen rich gas. The fuel cell system further comprises at least one housing, which is adapted to accommodate at least one hydrogen leaking unit, particularly the at least one fuel cell stack. The housing has an air inlet for flushing the housing from potentially leakage hydrogen by means of inlet air and an air outlet for exiting the potentially hydrogen contaminated air from the housing. The air outlet is directly or indirectly in fluid connection with the oxidizing agent.

### TECHNICAL FIELD

The present invention relates to a fuel cell system comprising at least one fuel cell stack and a reformer unit according to the preamble of claim 1.

### TECHNICAL BACKGROUND

In some mobile application devices e.g. on board of a vehicle, such as a ship, train, plane, truck, car, etc., it might be advantageous not to store pure hydrogen for fueling a fuel cell stack, but a hydrocarbon fuel, which is then reformed to hydrogen rich gas by means of a reformer unit for fueling at least one fuel cell stack.

In general, there are three known methods of reforming gaseous or liquid hydrocarbon fuels into hydrogen: catalytic steam reforming, partial oxidation reforming and auto-thermal reforming.

In catalytic steam reforming processes, a mixture of steam and hydrocarbon fuel is exposed to a suitable catalyst, like nickel, at a high temperature (between 700° C. and 1000° C.). The reaction is highly endothermic and requires an external source of heat and a source of steam.

In partial oxidation reforming processes, a mixture hydrogen fuel and an oxygen containing gas, like ambient air, are brought together within a reaction chamber and subjected to an elevated temperature, preferably in the presence of a catalyst. The catalyst used is normally a noble metal or nickel and the temperature is between 700° C. and 1700° C. The reaction is highly exothermic and once started generates sufficient heat to be self sustaining. In order to promote the oxidation reaction, it is necessary to preheat the feed fuel and to reduce temperature variations in the reactor.

Auto-thermal reforming processes are a combination of steam reforming and partial oxidation reforming. Waste heat from the partial oxidation reforming reaction is used to heat the endothermic steam reforming reaction.

The natural by-products of all reforming processes are carbon monoxide and carbon dioxides, and also other by-products such as sulphur, olefins, benzene, methyl amid and higher molecular weight aromatics. These by-products may be harmful to the fuel cells and should therefore be removed by subsequent cleaning steps outside the reformer reactor.

Another issue in some mobile applications devices is the need to keep the inside of the mobile application device as hydrogen free as possible. Nevertheless, the fuel cell stack itself and the various units arranged between the reformer and the fuel cell stack are potential hydrogen leakage sources.

It has been therefore previously suggested to either ventilate the space surrounding the hydrogen containing parts and route this out of the mobile application device or the make the space surrounding inert so that the hydrogen cannot react if released into it.

Both measures are technically feasible but create possible secondary issues with hazardous zoning outside the mobile application device when ventilated.

It is therefore object of the present invention to provide a fuel cell system which is safer and easier to construct and would also enable flexible installation location of the reformer and fuel cell stacks onboard of a mobile application device.

This object is solved by a fuel cell system according to claim 1.

### SUMMARY OF THE INVENTION

In the following a fuel cell system comprising at least one fuel cell stack and a reformer unit is described. Thereby, the reformer unit is adapted to convert hydrocarbon fuel into a hydrogen rich gas, wherein the reformer unit comprises an oxidizing agent inlet, a hydrocarbon fuel inlet, a reaction chamber, in which the oxidation agent and the hydrocarbon fuel are reacted to hydrogen rich gas and byproducts. The hydrocarbon fuel is preferably methanol, but it is also possible to use natural gas, syngas, or even diesel or gasoline as hydrogen source. The reformer unit may be any kind of reformer unit, but an autothermal reformer is preferred.

The reformer unit further comprises a reaction chamber outlet for exiting the hydrogen rich gas, wherein the hydrogen rich gas is fed into the at least one fuel cell stack as reactant.

The fuel cell stack is preferably a PEM (proton-exchange membrane) fuel cell stack comprising a plurality of membrane electrode assembly and bipolar plates which are alternatingly stacked for forming a fuel cell stack body. Each bipolar plate comprises at least two so called flow field plates, which are placed on top of each other and have a flow field for the reactants at one side and a flow field for a cooling fluid on the other side. Thereby, the flow fields form channels through which the respective fluids stream.

In order to avoid any fluid leaks and to achieve fluid tightness of the fuel cell stack, the stack body is compressed in stacking direction with the aid of a compression element. However, this fluid tightness might slightly deteriorate over time e.g. due to wear of the sealings or due to slight variations in the compression force, which might result in a hydrogen leakage.

Besides the fuel cell stack, the fuel cell system may also comprise further units which might potentially leak hydrogen. In order to prevent the fuel cell system from potentially hazardous situations due to an unwanted accumulation of hydrogen, it is suggested that the fuel cell system further comprises at least one housing, which is adapted to accommodate at least one hydrogen leaking unit, particularly the at least one fuel cell stack, wherein the housing has an air inlet for flushing the housing from potentially leakage hydrogen by means of inlet air and an air outlet for exiting the potentially hydrogen contaminated air from the housing.

However, as mentioned above, the air, which is ventilating the housing, needs to be routed out of a mobile application device, as it might create other potentially hazardous zones at or around the mobile application device. Therefore, the inventors have suggested, to guide the ventilating air exiting the air outlet not to the outside of the mobile application device, but to the reformer unit for burning off (flaring) leakage hydrogen in the reaction chamber of the reformer unit. For that, the air outlet of the housing is in fluid connection with the oxidizing agent inlet of the reformer unit so that the reformer unit is fed with the potentially hydrogen contaminated air exiting from housing. Thereby the air outlet of the housing can be directly in connection with the oxidizing agent inlet, i.e. there are no other units or housings arranged in between, or the air outlet is indirectly in fluid connection with the oxidizing agent inlet, i.e. there might be a further component between both the outlet and the inlet, e.g. a further housing.

Thereby, it is preferred that the air which is ventilating the housing is used as process air for the reformer unit. With other words, the oxidizing agent inlet of the reformer unit is supplied only with air streaming through the housing.

However, it is also possible that the reformer unit has a further oxidizing agent inlet, which might be supplied in addition with fresh air, which has not been guided through the housing. This might be advantageous in case an unexpected large amount of fresh air is required by the reformer unit.

Of course, it is also possible to have only a single oxidizing agent inlet to the reaction chamber itself, but to provide upstream of the main oxidation agent inlet to the reaction chamber a possibility to feed fresh air, which has not been guided through the housing, to the possibly hydrogen contaminated air ventilated through the housing. Thus, the possibly hydrogen contaminated air and air from the environment can be mixed. Thereby it is possible to dilute the amount of hydrogen, which is contained in the possibly hydrogen contaminated air, e.g. due to safety aspects.

Besides the at least one fuel cell stack, there might also be other units, which are arranged between the reformer unit and the at least one fuel cell stack and which might leak hydrogen. It is therefore suggested to include also these units into housings and vent them by air which is then supplied to the reaction chamber of the reformer for flaring leakage hydrogen.

Even if each potential hydrogen leaking unit might be included in a separate housing and have a separate air inlet and air outlet, it is preferred to accommodate at least one further hydrogen leaking unit in the same housing as the at least one fuel cell stack, or to at least arrange the housing in series. For example, in case the units are arranged in separate housings it is preferred if e.g. the air outlet of the fuel cell stack accommodating housing is fluidly connected to the air inlet of a housing which accommodates at least one further hydrogen leaking unit and the outlet of the further housing is then in fluid connection with the oxidizing agent inlet of the reformer and/or a further housing inlet which is arranged downstream of the second housing. This is particularly preferred for units, which are supposed to provide hydrogen generated in the reformer unit to the fuel cell stack as they are the most likely units to leak hydrogen in a potentially hazardous amount.

However, since the effluent of the at least one fuel cell stack usually also contains (unused) hydrogen it is also preferred to accommodate these units in housings. Preferably, the unused hydrogen is fed into a burner unit which is part of the reformer unit and which in turn which is used for heating the reaction chamber of the reformer unit. The housing for accommodating the units which are arranged between the fuel cell stack and the burner might be the same housing as the housing for the units which are arranged between the reformer and the fuel stack inlet. This allows for a very compact and space saving system.

According to a further embodiment, one of the at least one hydrogen leaking unit is a hydrogen storage buffer arranged between the reformer outlet and the at least one fuel cell stack, which is adapted to store hydrogen provided by the reformer unit for balancing a hydrogen demand of the at least one fuel cell stack. Hydrogen storage buffers are used for storing a surplus of hydrogen which can be used e.g. during a start-up phase of the reformer unit, when the reformer unit is not yet producing sufficient hydrogen for fueling the fuel cell stack. This allows for a fast operating start of the system. However, hydrogen storage units are prone to leakage. Therefore, venting the housing accommodating the hydrogen buffer avoids hazardous situations.

Another potential hydrogen leakage source is the piping itself, and/or the connecting elements, such as valves and/or fittings. Consequently, it is preferred to include also these elements into a housing, wherein the housing can be a separate housing and/or the same housing as the one which accommodates at least one other hydrogen leaking source, e.g. the hydrogen buffer, and/or the fuel cell stack.

Besides the units which are arranged to store or guide purified hydrogen to the fuel cell stack, the fuel cell system and particularly the reformer unit may further comprise units for cleaning the hydrogen rich gas exiting the reaction to chamber to hydrogen which might be useable in a fuel cell stack. Such units may be e.g. a purifier and/or a methanator depending on the hydrocarbon fuel which is used as hydrogen source. However, also these units might be potential hydrogen leakage sources, so it is also preferable to include these units in at least one housing, which is also vented in the same way as mentioned above.

According to a further preferred embodiment, the reformer unit is also included in a housing, wherein the housing can be a separate housing and/or the same housing as the one which accommodates at least one other hydrogen leaking source, particularly one of the hydrogen purifying devices. Thereby, also the hydrogen generating devices, which might also leak hydrogen are vented. Additionally, a compact and space-saving fuel cell system can be provided.

According to a further preferred embodiment, the fuel cell system comprises two housings, which are fluidly interconnected. Thereby, the first housing comprises the at least one fuel cell stack and the second housing comprise the reformer unit and optional purifying units. The hydrogen leaking units, which are arranged between the at least one fuel cell stack and the reformer unit may then be also accommodated in the first housing and/or in the second housing.

Alternatively, it is also preferred that the fuel cell system comprises three housing, wherein the third housing then accommodates the hydrogen leaking units which are arranged between the reformer unit and at least one fuel cell stack.

Thereby it is particularly preferred, that the air outlet of the second housing is fluidly connected to the oxidation agent inlet of the reformer unit.

Depending on whether there are two or three housings, the air inlet of the second housing is either fluidly connected to the air outlet of the first housing (two housings) or to the air outlet of the third housing.

Both above-described embodiments allow for a compact and space saving fuel cell system.

As mentioned above, each housing may comprise an air inlet and air outlet, wherein the air outlets may be individually connected to the oxidating agent inlet of the reformer unit. This also means that each housing may be equipped with at least one fan, which provides the air stream through the housing.

Thereby, the fan or a fan array may have an air-sucking-in-port and an air expelling port. The fan or fan array may be arranged inside and/or outside of the housing. Thereby it is preferred that, in case the fan or fan array is arranged outside the housing, the air-sucking-in-port is in fluid connection with the air outlet of the housing or provides the air outlet of the housings. However, it is also possible to connect the air expellant port of the fan or fan array with the housing inlet, so that air is blown through the housing and to the oxidizing agent inlet of the reformer unit. Alternatively or additionally, in case the fan or fan array is arranged inside of the housing, the air expellant port of the fan or fan array is in fluid connection with the air outlet of the housing or provides the air outlet of the housing. It goes without saying that also two or more fans or fan arrays may be present, wherein at least one is arrange insides the housing, whereas at least one other is arranged outside the housing.

Preferably the fan or fan array is arranged inside of at least one of the housings.

However, the possibility to fluidly interconnect the housings allows for a further preferred embodiment in which only one housing of at least two housings is equipped with a fan or fan array. Preferably, all housings are fluidly interconnected, but only a single housing is equipped with a fan or fan array. This allows for an economic fuel cell system.

Thereby it is particularly preferred, if the fan or fan array is the fan or fan array of the reformer unit. Thereby already existing elements can be used for venting all fluidly interconnected housings and provide a hydrogen free environment in the housing and also in the surroundings of the fuel cell system, and optionally also of a mobile application which comprise the fuel cell system.

Even if the fuel cell system has been mainly described in relation to a mobile application, it also possible to use the above described fuel cell system in stationary applications.

Further preferred embodiments are defined in the dependent claims as well as in the description and the figures. Thereby, elements described or shown in combination with other elements may be present alone or in combination with other elements without departing from the scope of protection.

In the following, preferred embodiments of the invention are described in relation to the drawings, wherein the drawings are exemplarily only, and are not intended to limit the scope of protection. The scope of protection is defined by the accompanied claims, only.

### SHORT DESCRIPTION OF THE FIGURES

The figures show:

FIG. 1: a schematic illustration of a fuel cell system according to a preferred embodiment;

FIG. 2: a schematic illustration of a fuel cell system according to a further preferred embodiment;

FIG. 3: a schematic illustration of a fuel cell system according to a further preferred embodiment;

FIG. 4: a schematic illustration of a fuel cell system according to a further preferred embodiment;

FIG. 5: a schematic illustration of a fuel cell system according to a further preferred embodiment;

FIG. 6: a schematic illustration of a fuel cell system according to a further preferred embodiment;

FIG. 7: a schematic illustration of a fuel cell system according to a further preferred embodiment;

FIG. 8: a schematic illustration of a fuel cell system according to a further preferred embodiment;

FIG. 9: a schematic illustration of a fuel cell system according to a further preferred embodiment;

FIG. 10: a schematic illustration of a fuel cell system according to a further preferred embodiment;

FIG. 11: a schematic illustration of a fuel cell system according to a further preferred embodiment; and

FIG. 12: a schematic illustration of a fuel cell system according to a further preferred embodiment.

### DETAILED DESCRIPTION OF THE FIGURES

In the following same or similar functioning elements are indicated with the same reference numerals. It should be explicitly noted that individual features depicted only in one embodiment of one FIG. can also be included in all other embodiments shown in the FIGS.

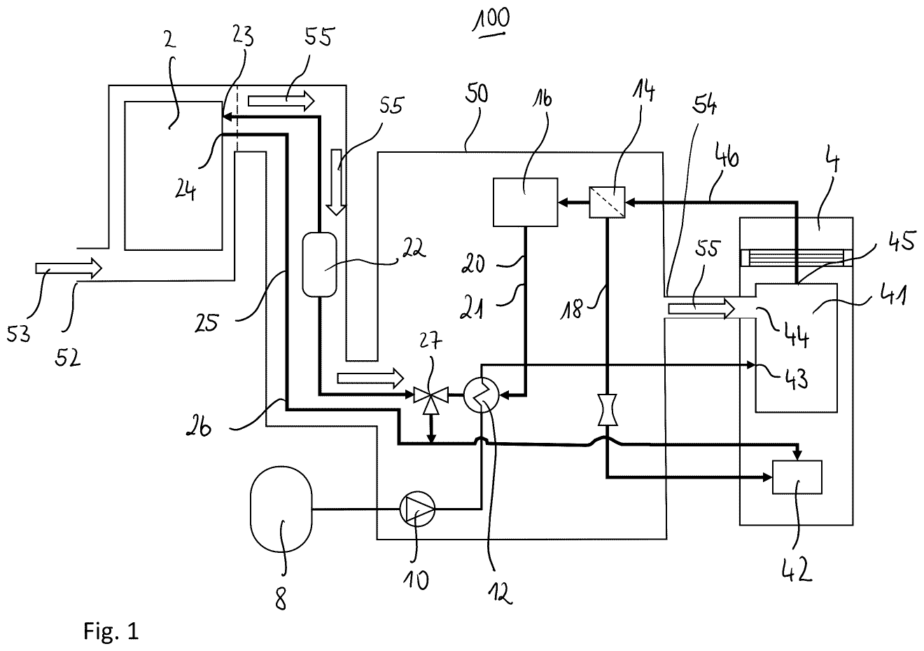

FIGS. 1 to 12 illustrate schematically a fuel cell system 100 comprising at least one fuel cell stack 2 and a reformer unit 4. The reformer unit 4 is adapted to convert hydrocarbon fuel into a hydrogen rich gas. For that hydrocarbon fuel is reacted with an oxidizing agent, particularly with air, in the presence of a catalyst and heat to generate a hydrogen rich gas and byproducts.

In general, there are three known methods of reforming gaseous or liquid hydrocarbon fuels into hydrogen: catalytic steam reforming, partial oxidation reforming and auto-thermal reforming.

In catalytic steam reforming processes, a mixture of steam and hydrocarbon fuel is exposed to a suitable catalyst, like nickel, at a high temperature (between 700° C. and 1000° C.). The reaction is highly endothermic and requires an external source of heat and a source of steam.

In partial oxidation reforming processes, a mixture hydrogen fuel and an oxygen containing gas, like ambient air, are brought together within a reaction chamber and subjected to an elevated temperature, preferably in the presence of a catalyst. The catalyst used is normally a noble metal or nickel and the temperature is between 700° C. and 1700° C. The reaction is highly exothermic and once started generates sufficient heat to be self sustaining. In order to promote the oxidation reaction, it is necessary to preheat the feed fuel and to reduce temperature variations in the reactor.

Auto-thermal reforming processes are a combination of steam reforming and partial oxidation reforming. Waste heat from the partial oxidation reforming reaction is used to heat the endothermic steam reforming reaction.

The hydrocarbon fuel is preferably methanol, but it is also possible to use natural gas, syngas, or even diesel or gasoline as hydrogen source. The reformer unit 4 may be any kind of reformer unit, but an autothermal reformer is preferred.

In the illustrated embodiments of FIGS. 1 to 12, hydrocarbon fuel 6 is stored in a reservoir 8 and transported by means of a pump 10 from there to a heat exchanger 12, in which the hydrocarbon fuel 6 is preheated, and further to the reformer unit 4.

The reformer unit 4 is only schematically illustrated in the FIGS., but usually comprise a reaction chamber 41 in which the reforming reaction takes place. For providing the heat in the reaction chamber 41, the reformer unit 4 is further equipped with a burner 42, the function of which will be described further below. The reformer unit 4 and in particularly the reaction chamber 41 further comprise a fuel inlet 43 and at least one oxidizing agent inlet 44 for supplying the reactants to the reaction chamber 41.

The reaction chamber 41 and the reformer unit 4, respectively, further comprise a reaction chamber outlet 45 for exiting the reformed hydrogen rich gas 46 together with byproducts.

The natural byproducts of all reforming processes are carbon monoxide and carbon dioxides, and also other by-products such as sulphur, olefins, benzene, methyl amid and higher molecular weight aromatics. These byproducts may be harmful to the fuel cells and should therefore be removed from the hydrogen rich gas by subsequent cleaning steps outside the reformer unit 4.

For cleaning the hydrogen rich gas from unwanted byproducts, two possible units are illustrated in FIG. 1, a purifier 14 and a methanator 16. The purifier 14 separates unwanted burnable byproducts from the hydrogen rich gas, particularly remaining unreformed hydrocarbon fuel parts. These filtered byproducts 18 are the guided back to the burner 42, in which they are burned for providing the heat necessary for the reforming process. In the methanator 16 the hydrogen rich gas 46 is cleaned from remaining carbon monoxide which is particularly harmful for fuel cell stacks 2.

The now purified hydrogen 20 is guided through a hydrogen supply piping 21 to the at least one fuel cell stack 2. For balancing the hydrogen supply for the fuel cell stack 2, a storage buffer 22 is arranged upstream of the fuel cell stack 2. Hydrogen storage buffers 22 are used for storing a surplus of hydrogen 20 which can be used for fueling the fuel cell stack 2, e.g. during a start-up phase of the reformer unit 4, when the reformer unit 4 is not yet producing sufficient hydrogen for fueling the fuel cell stack 2.

The fuel cell stack 2 is preferably a PEM (proton-exchange membrane) fuel cell stack comprising a plurality of membrane electrode assembly and bipolar plates which are alternatingly stacked for forming a fuel cell stack body. Each bipolar plate comprises at least two so called flow field plates, which are placed on top of each other and have a flow field for the reactants at one side and a flow field for a cooling fluid on the other side. Thereby, the flow fields form channels through which the respective fluids stream. For supplying hydrogen to the fuel cell stack 2, the fuel cell stack comprises a hydrogen inlet 23 and a hydrogen outlet 24, which distributes hydrogen to and from the bipolar plates of the fuel cell stack 2 on the anodes side. Likewise, the fuel cell stack 2 is equipped with an oxidant inlet and outlet (not illustrated) for providing oxygen to the fuel cell stack, and a coolant inlet and outlet, also not illustrated, for providing a cooling fluid to the fuel cell stack 2.

Basically, in the fuel cell stack 2 hydrogen 20 and oxygen (not illustrated) are reacted to water and electric energy by means of the membrane. Since the basic principle of a fuel cell are known, a detailed description is omitted, but is supposed to be known by the skillful reader. Since usually not all of the hydrogen 20 is used during the conversion process, hydrogen containing gas 25 exits the hydrogen outlet.

This hydrogen containing gas is then guided back to the reformer unit and particularly to the burner 42, by means of a fuel cell effluent piping 26. In the burner 42 the remaining hydrogen is burned for providing the heat necessary for the reforming process.

The hydrogen supply piping 21 as well as the fuel cell effluent piping 26 may be further equipped with other components which are not illustrated. In particular, the hydrogen supply line 21 may be equipped with a valve 27, which allows for a rerouting of parts of the hydrogen 20 in the hydrogen supply line 21 to the fuel cell stack effluent piping 28. Thereby, additional hydrogen may be provided to the burner 42, in case the hydrogen containing gas 25 exiting the fuel cell stack 2 does not comprise sufficient hydrogen for operating the burner 42 or in case the fuel cell stack does not require the provided hydrogen amount or no hydrogen at all, e.g. during shut down of the fuel cell system.

Since each of the above described components in the fuel cell system might leak hydrogen, which can in turn accumulate to create potentially hazardous zones in the system itself or in the environment of the system, it is further suggested to accommodate the potentially hydrogen leaking components of the fuel cell system 100, particularly the fuel cell stack 2 as major hydrogen leakage source, in at least one housing 50.

The FIGS. 1 to 12 illustrate various embodiments of housing variations, accommodating the hydrogen leaking components of the fuel cell system 100.

The housing 50 has an air inlet 52 for flushing the housing 50 from potentially leakage hydrogen by means of fresh or inlet air 53 and an air outlet 54 for exiting the potentially hydrogen contaminated air 55 from the housing 50.

However, as mentioned above, the air, which is ventilating the housing 50, needs to be routed out of a mobile application device, as it might create other potentially hazardous zones at or around the mobile application device. Therefore, the potentially hydrogen contaminated air 55 does not exit the air outlet 54 to the outside of the mobile application device, but to the reformer unit 4 and particularly the reaction chamber 41 for burning off (flaring) leakage hydrogen in the reaction chamber 41 of the reformer unit 4. For that, the air outlet 54 of the housing 50 is in fluid connection with the oxidizing agent inlet 44 of the reformer unit so that the reformer unit is fed with the potentially hydrogen contaminated air exiting from housing.

Thereby, the potentially hydrogen contaminated air 55, which is ventilating the housing 50 is used as process air for the reformer unit 4. With other words, the oxidizing agent inlet 44 of the reformer unit 4 is supplied only with air 55 streaming through the housing 50, as is illustrated in FIG. 1 and FIGS. 4 to 12.

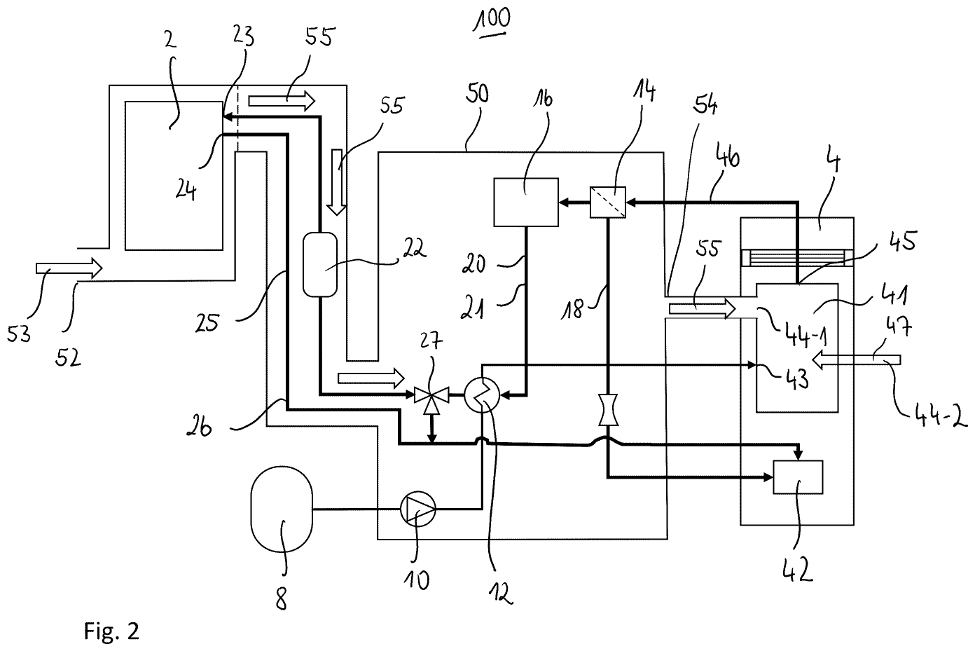

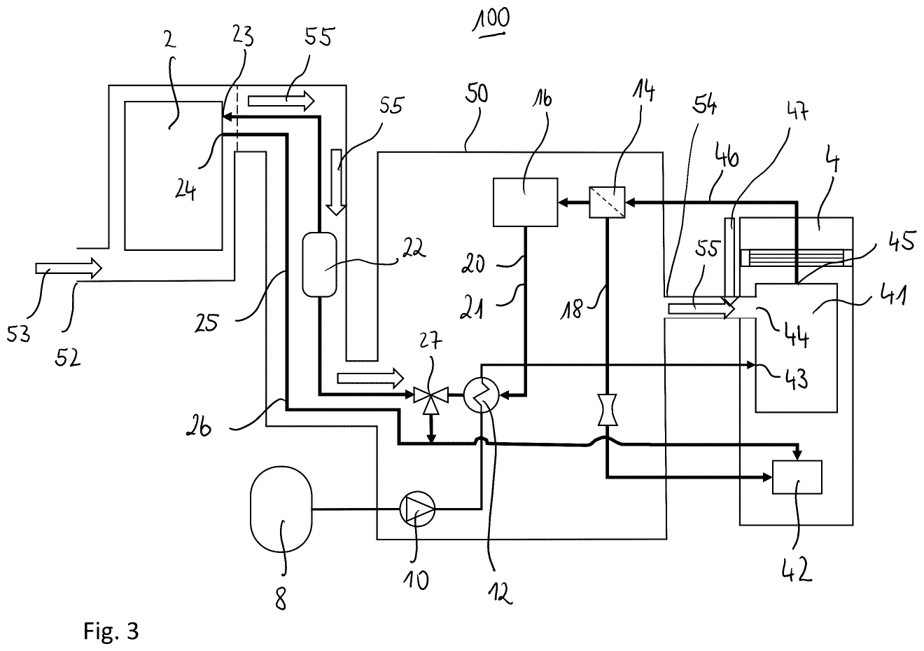

However, it is also possible that the reformer unit 4 has a further oxidizing agent inlet 44-2, which might, in addition, supply fresh air 47 to the reaction chamber 41, which has not been guided through the housing 50, as is illustrated in FIG. 2. This additional oxidizing agent supply can also be included into at least one of the embodiments, shown in FIGS. 3 to 12. This might be advantageous in case an unexpected large amount of fresh air is required by the reformer unit 4.

Of course, it is also possible to have only a single oxidizing agent inlet 44 to the reaction chamber 41 itself, but to provide upstream of the main oxidation agent inlet 44 to the reaction chamber 41 a possibility to feed fresh air 47, which has not been guided through the housing 50, to the possibly hydrogen contaminated air 55 ventilated through the housing 50. Thus, the possibly hydrogen air 55 and air 47 from the environment can be mixed. Thereby it is possible to dilute the amount of hydrogen which is contained in the possibly hydrogen contaminated air 55, e.g. due to safety aspects. Such an embodiment is illustrated in FIG. 3, but can be also provided in any other embodiment, shown in the FIGS.

For transporting the air through the housing 50 and to the reformer unit 4, a fan or fan array 56 might be arranged which can be arranged outside of the housing 50 as is illustrated in FIGS. 1 to 3. Since the reformer unit 4 usually already has a fan or fan array, for providing air as oxidizing agent to the reaction chamber, it is preferred to use this fan or fan array.

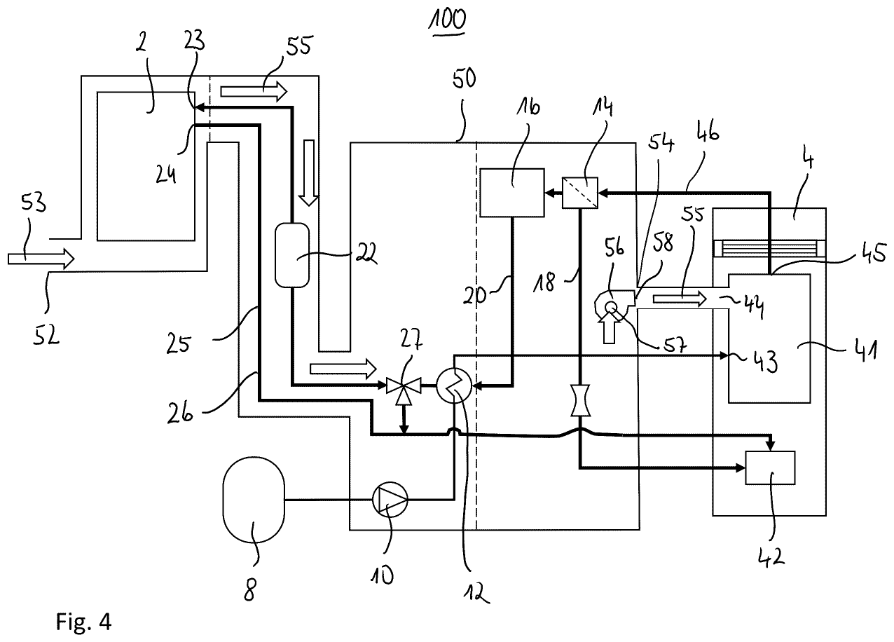

Besides an arrangement of the fan or fan array 56 outside of the housing 50 it is also possible to arrange the fan or fan array 56 inside of the housing 50 as is illustrated in FIG. 4. Even if the fan or fan array 56 may be arranged somewhere in the housing 50, it is particularly preferred to arrange the fan or fan array 56 in the vicinity of the air outlet 54 of the housing for providing sufficiently pressurized air to the reformer unit 4.

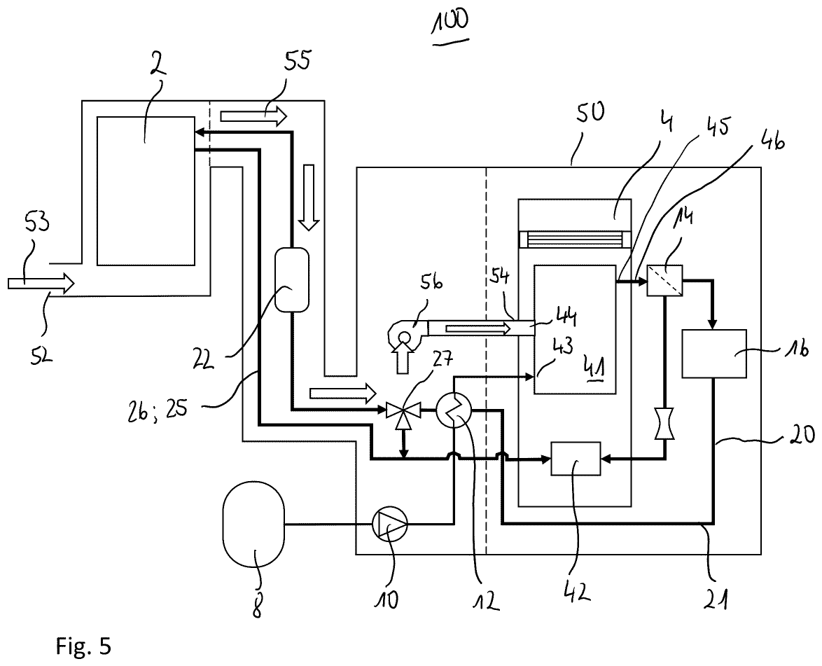

FIG. 5 illustrates a further embodiment in which also the reformer unit 4 is accommodated in the housing 50. The air outlet of the housing is then provided by the fan of fan array 56 itself. The fan or fan array 56 has a sucking-in-port 57 and an air expellant port 58. The air outlet 54 of the housing 50 can then either be regarded as the sucking in port 57 of the fan 56 or as the air expellant port 58.

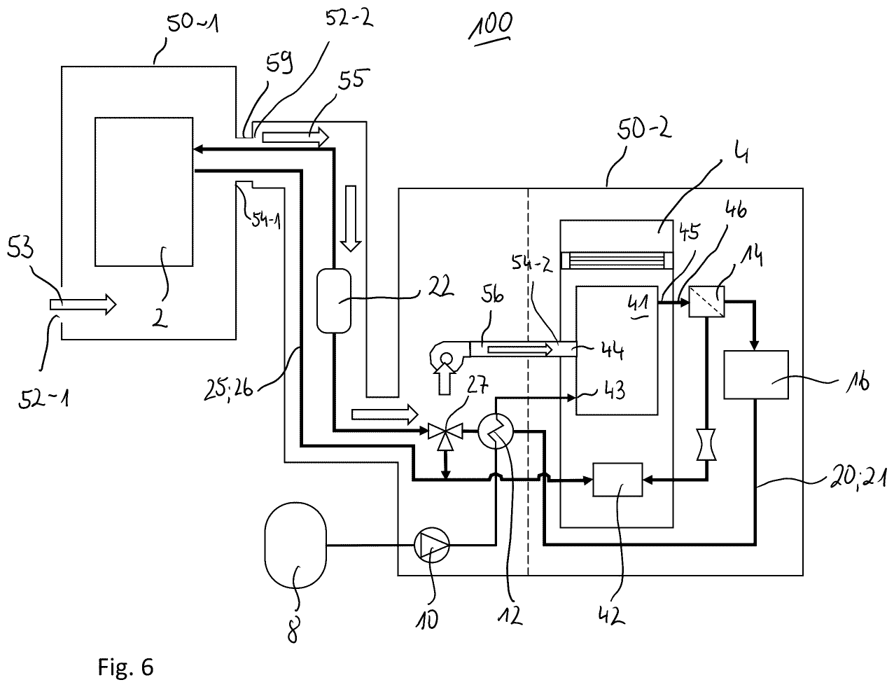

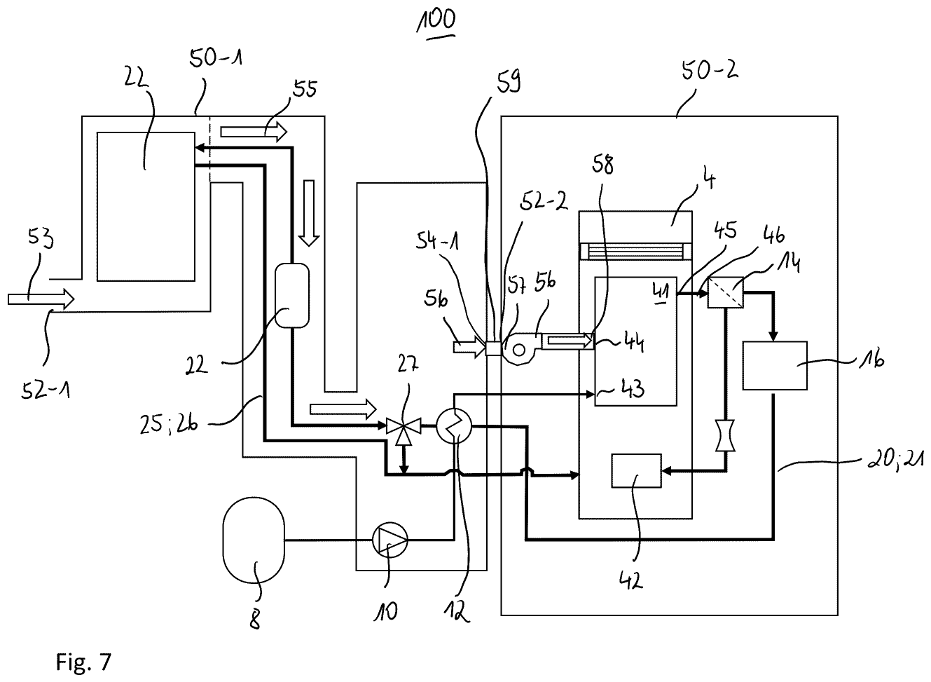

FIGS. 6, and 7 illustrate embodiments with not only a single housing 50, but two housing 50-1, 50-2. In the illustrated embodiment of FIG. 6, the at least one fuel cell stack 2 is arranged in a first housing 50-1, wherein the reformer unit 4 and other potentially hydrogen leaking components, e.g. the hydrogen storage buffer 22, the valve 27 or the piping 26, are arranged in a second housing 50-2.

Of course, it is also possible to arrange the components in the housings 50-1, 50-2 differently. FIG. 7 illustrates an embodiment, wherein fuel cell stack 2 and the hydrogen leaking unit which are not directly related to the reformer unit 4, e.g. the hydrogen storage buffer 22, the valve 27 or the piping 26 the storage buffer in the first housing 50-1, wherein the second housing 50-2 accommodates the reformer unit 4 and the reformer unit related components, such as the purifier and/or the methanator. The fan or fan array 56 may be either included in the reformer housing 50-2 as illustrated in FIG. 7 or can also be included in the first hosing 50-1.

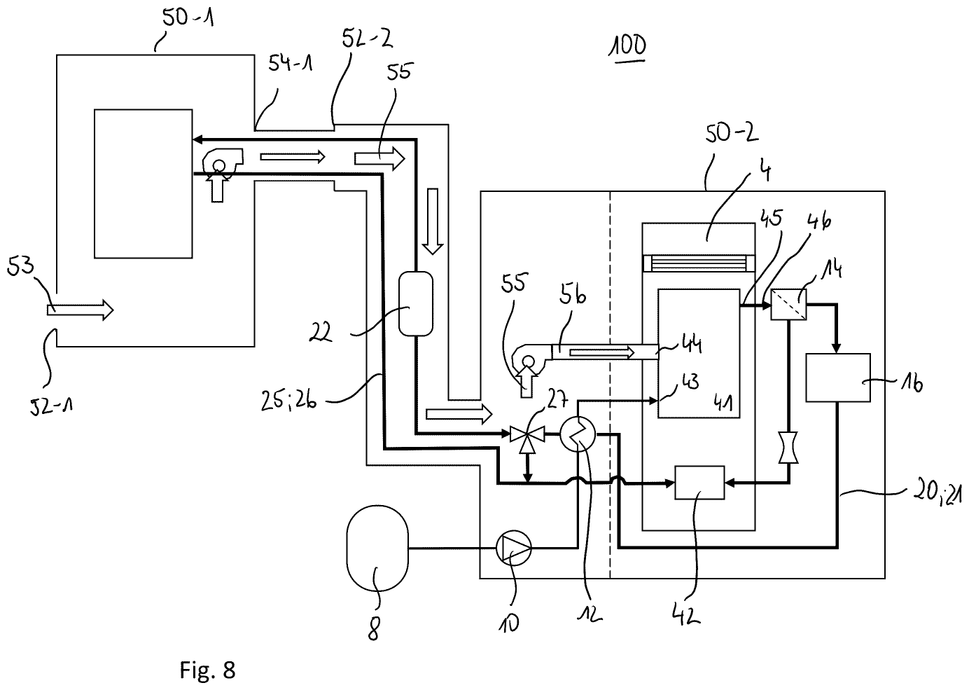

The first and the second housing 50-1, 50-2 are fluidly connected by a housing connection element 59. Being fluidly connected allows for use of a single fan or fan array 56 for the entire housing arrangement. However, in case the housing is very large or has an inconvenient design, a further fan or fan array 56-2 may be added to the fuel cell system as is illustrated in FIG. 8. In FIG. 8, the additionally fan or fan array is arranged at air outlet 54-1 of the first housing 50-1 and is adapted to blow air from the first housing 50-1 into the second housing 50-2. In the second housing 50-2 a second fan or fan array 56-2 is arranged which is adapted to provide air at the oxidizing agent inlet 44 of the reformer unit 4.

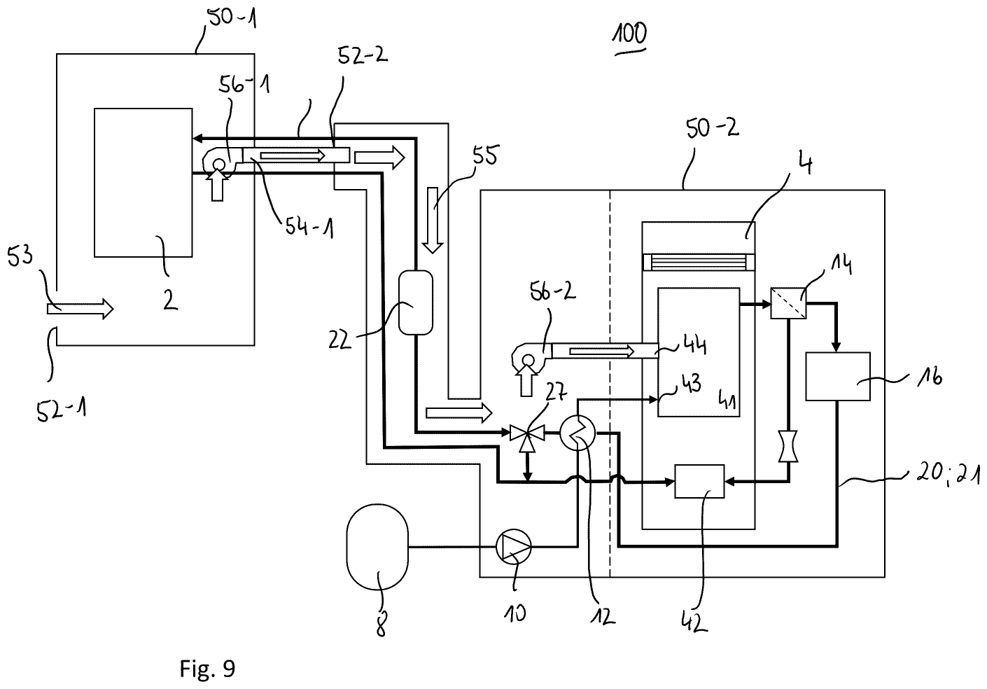

Since usually the piping tubes itself are not hydrogen leaking, but only the fittings, it ai also possible, as illustrated in FIG. 9, to arrange the fan 56-1 in such a way that, the fan 56-1 is connecting the housings 50-1 and 50-2. Thereby the sucking in port 57-1 of fan 56-1 is fluidly connected to the air outlet 54-1 of the first housing 50-1 and the air expellant port 58-1 is fluidly connected to the air inlet 52-2 of the second housing 50-2.

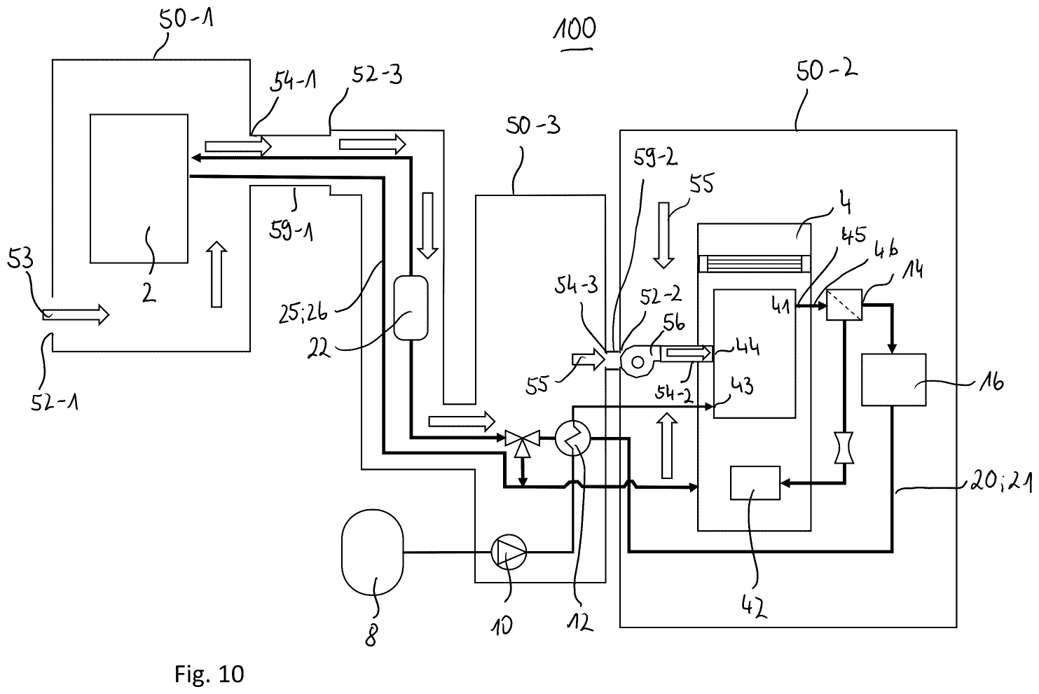

Besides two housings 50-1, 50-2 as illustrated in FIGS. 6 to 9, it is also possible to provide three housings, as is illustrated in FIG. 10, wherein the first housing 50-1 accommodates the fuel cell stack 2, the second housing 50-2 the reformer unit and its components, and the third housing 50-3 accommodates the remaining hydrogen leaking components. As mentioned above, also the three housings are preferably in fluid connection so that only a single fan or fan array 56 may be provided, which transports the air through the housings 50-1, 50-2, 50-3. As the reformer unit is usually already equipped with a fay or fan array 56 it is preferred to used this fan as air propelling device.

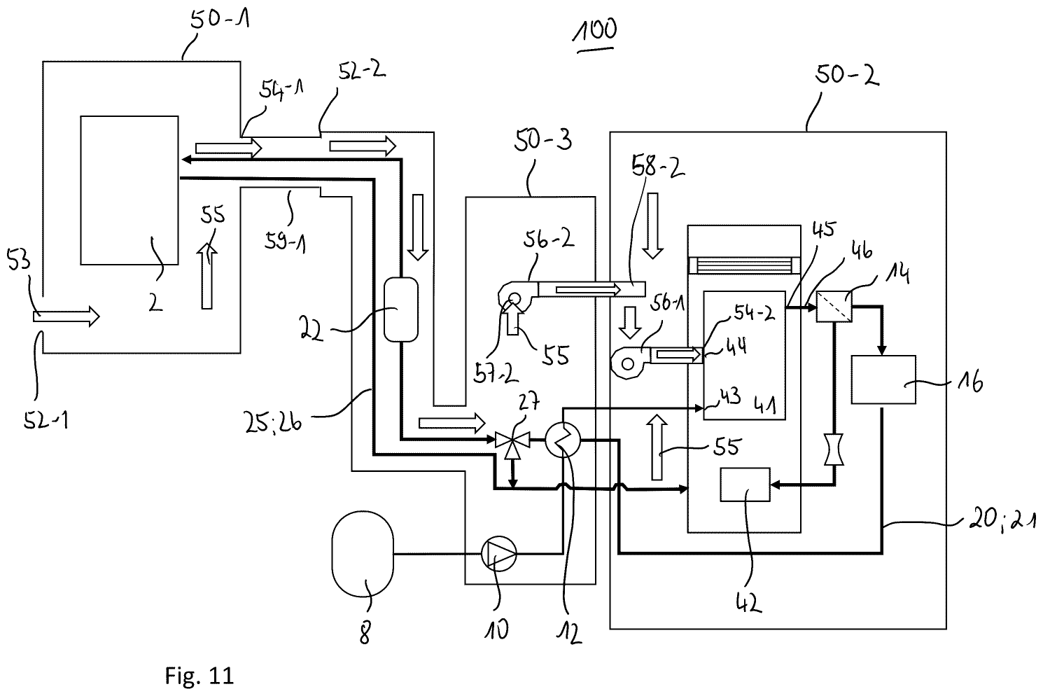

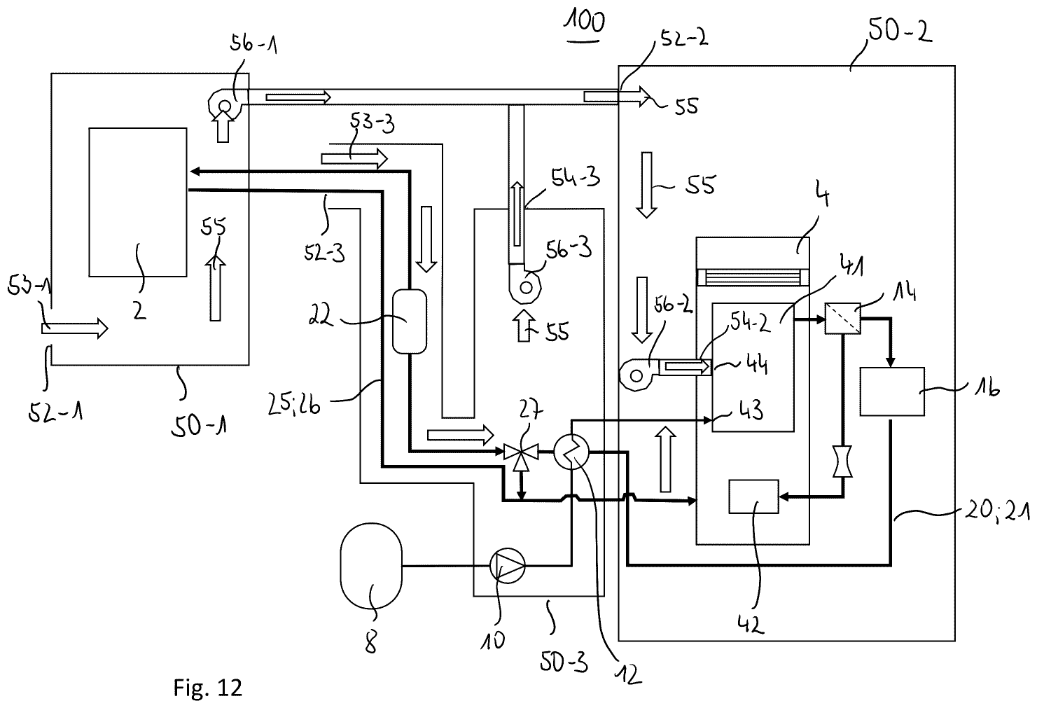

Nevertheless and as illustrated in FIG. 11, more than one fan 56 may be provided. It is even possible to equipe each housing 50-1, 50-2, 50-3 with a fan, as is illustrated in FIG. 12. FIG. 12 further illustrates that the fans do not necessarily be in fluid communication with the air outlets of the housings but could be interconnected outside of the housings. In this case it is also possible that the housings themselves are not fluidly interconnected.

In summary by feeding potentially hydrogen contaminated air to the reaction chamber of the reformer unit and flaring it off, provides a neat possibility to provide a safe and hydrogen free environment. This is particularly useful in mobile applications, such as e.g. ships, planes, trains and/or other vehicles, where safety concerns require to ensure that hydrogen is no accumulating anywhere in or near the mobile application.

It should be further noted that all of the above described features can be present alone or in different combination than the mentioned ones without deviating from the scope of the invention.

### REFERENCE NUMERALS

100 fuel cell system
2 fuel cell stack
4 reformer unit
6 hydrocarbon fuel
8 reservoir
10 pump
12 heat exchanger
41 reaction chamber
42 burner
43 fuel inlet
44 oxidizing agent inlet
45 reaction chamber outlet
46 reformed hydrogen rich gas
47 air from the environment
14 purifier
16 methanator
18 filtered byproducts
20 purified hydrogen
21 hydrogen supply piping
22 storage buffer
23 hydrogen inlet
24 hydrogen outlet
25 hydrogen containing gas
26 effluent piping
27 valve
28 effluent piping
50 housing
50-1, 50-2, 50-3 housings
52, 52-2 air inlet
53 fresh or inlet air
54, 54-1 air outlet
55 hydrogen contaminated air
56, 56-2 fan or fan array
57, 57-1 sucking-in-port
58, 58-1 air expellant port
59 housing connection element

The invention claimed is:

1. A fuel cell system comprising at least one fuel cell stack and a reformer unit, wherein the reformer unit is adapted to convert hydrocarbon fuel into a hydrogen rich gas, wherein the reformer unit comprises at least one oxidizing agent inlet, a hydrocarbon fuel inlet, a reaction chamber, in which the oxidation agent and the hydrocarbon fuel are reacted to hydrogen rich gas and byproducts, and a reaction chamber outlet for exiting the hydrogen rich gas, wherein the hydrogen rich gas is fed into the at least one fuel cell stack as reactant, wherein the fuel cell system further comprises at least one housing, which is adapted to accommodate at least one hydrogen leaking unit, wherein the housing has an air inlet for flushing the housing from potentially leakage hydrogen by means of inlet air and an air outlet for exiting the potentially hydrogen contaminated air from the housing, wherein the air outlet of the housing is directly or indirectly in fluid connection with the oxidizing agent inlet of the reformer unit so that the reformer unit is fed with the potentially hydrogen contaminated air exiting from housing.

2. The fuel cell system according to claim 1, wherein the hydrogen leaking unit is at least one fuel cell stack.

3. The fuel cell system according to claim 1, wherein the fuel cell system comprises at least one further housing which is adapted to accommodate at least one further hydrogen leaking unit, which is arranged between the reformer unit and the at least one fuel cell stack, wherein the housing has an air inlet for flushing the housing from potentially leakage hydrogen by means of inlet air and an air outlet for exiting the potentially hydrogen contaminated air from the housing and wherein the air outlet of the housing is in fluid communication with the oxidizing agent inlet of the reformer unit.

4. The fuel cell system according to claim 3, wherein the housings are fluidly interconnected.

5. The fuel cell system according to claim 3, wherein the housings are arranged in series, whereby the air outlet of a first housing is connected to the air inlet of a subsequent housing, and the air outlet of a last housing is connected to the oxidizing agent inlet of the reformer unit.

6. The fuel cell stack according to claim 1, wherein at least one of the housings accommodates more than one hydrogen leaking unit.

7. The fuel cell system according to claim 1, wherein one of the at least one hydrogen leaking units is a hydrogen storage buffer arranged between the reformer outlet and the at least one fuel cell stack, which is adapted to store hydrogen provided by the reformer unit for balancing a hydrogen demand of the at least one fuel cell stack.

8. The fuel cell system according to claim 1, wherein one of the at least one hydrogen leaking units is selected from the group consisting of a piping, a piping connection unit, a valve, a fitting.

9. The fuel cell system according to claim 1, wherein one of the at least one hydrogen leaking unit is a purification unit for purifying the hydrogen rich gas generated in the reaction chamber of the reformer unit to pure hydrogen for use in the at least one fuel cell stack.

10. The fuel cell system according to claim 9, wherein the purification unit is a purifier or a methanator.

11. The fuel cell system according to claim 1, wherein the reformer unit further comprise a burner for heating the reformer unit, wherein the burner is fed with exhaust hydrogen exiting the fuel cell stack.

12. The fuel cell system according to claim 1, wherein the reformer unit is accommodated in a housing.

13. The fuel cell system according to claim 1, wherein all hydrogen leaking units are accommodated in a single housing.

14. The fuel cell system according to claim 1, wherein the fuel cell system comprises two housings, wherein the first housing is adapted to accommodate at least the at least one fuel cell stack and the second housing is adapted to accommodate at least the reformer unit, wherein the air outlet of the second housing is fluidly connected to the oxidizing agent inlet of the reformer unit.

15. The fuel cell system according to claim 14, wherein at least one further hydrogen leaking unit is accommodated in the first and/or second housing.

16. The fuel cell system according to claim 14, wherein the fuel cell system comprises a third housing, which is adapted to accommodate the at least one further hydrogen leaking unit, wherein the air inlet of the third housing is fluidly connected to the air outlet of the first housing and the air outlet of the third housing is fluidly connected to the air inlet of the second housing.

17. The fuel cell system according to claim 1, wherein the fuel cell system is further equipped with a fan or a fan array having an air sucking in port and an air expelling port, wherein the air sucking in port is in fluid connection with the air outlet of at least one of the housings or provides the air outlet of at least one of the housings, or wherein the air expellant port is in fluid connection with the air outlet of the housing or provides the air outlet of the housings.

18. The fuel cell system according to claim 17, wherein the fan or fan array is arranged inside of at least one of the housings.

19. The fuel cell system according to claim 17, wherein the fan or fan array is the fan or fan array of the reformer unit.
